(19) United States
(12) Patent Application Publication
(10) Pub. No.: US 2023/0007559 A1
(43) Pub. Date: Jan. 5, 2023

(54) Communication Apparatus and Method for Handling a Handover in a Wireless Network

(71) Applicant: MEDIATEK INC., Hsin-Chu (TW)

(72) Inventors: Chiao-Chih Chang, Hsinchu City (TW); Yuan-Chieh Lin, Hsinchu City (TW); Chih-Yuan Tsai, Hsinchu City (TW); Chien-Chun Huang-Fu, Hsinchu City (TW); Yi-Lun Chen, Hsinchu City (TW); Ying-You Lin, Hsinchu City (TW)

(73) Assignee: MEDIATEK INC., Hsin-Chu (TW)

(21) Appl. No.: 17/844,049

(22) Filed: Jun. 19, 2022

Related U.S. Application Data
(60) Provisional application No. 63/217,423, filed on Jul. 1, 2021.

(51) Int. Cl. H04W 36/18; H04W 36/08; H04W 36/00

(52) U.S. Cl. CPC H04W 36/18; H04W 36/08; H04W 36/0016

(57) ABSTRACT

A communication apparatus comprises a radio transceiver and a modem processor. The radio transceiver is configured to transmit or receive wireless signals in a wireless network. The modem processor is coupled to the radio transceiver and configured to perform operations comprising: connecting to a first network device via a first communication link in a first frequency band; predicting a handover according to at least one of at least one measurement result or location information; connecting to a second network device via a second communication link in a second frequency band, after predicting the handover; performing the handover from the first network device to a third network device, to stop connecting to the first network device and to connect to the third network device via the first communication link in the first frequency band; and stopping connecting to the second network device, after performing the handover.

### CROSS REFERENCE TO RELATED APPLICATIONS

This application claims the benefit of U.S. Provisional Application No. 63/217,423, filed on Jul. 1, 2021. The content of the application is incorporated herein by reference.

### BACKGROUND

Long Term Evolution (LTE) is a set of enhancements to the Universal Mobile Telecommunications System (UMTS) mobile standard promulgated by 3rd generation partnership project (3GPP) for enabling high-speed packet communications. After LTE, 5G (fifth generation) New Radio (NR) is a new Radio Access Technology (RAT) developed by 3GPP for the 5G mobile network. The terminology 3GPP Radio Access Technology (RAT) may refer to the RAT promulgated or developed by 3GPP. The User Equipment (UE) is capable of communicating to the network device via the 3GPP RAT and/or the non-3GPP RAT (e.g., the WiFi or the wireless local access network (WLAN)) in the wireless network.

Nowadays, the UE usually faces the handover from the network device to the other network device due to the indoor moving and/or the outdoor transportation. The handover maybe from the 3GPP network device (e.g., a Node-B (NB), an evolved Node-B (eNB), a gNode-B (gNB)) to the other 3GPP network device, from the non-3GPP network device (e.g., the Access Point (AP)) to the other non-3GPP network device, or from the non-3GPP network device to the 3GPP network device, but is not limited herein. The UE cannot transmit and receive data during performing the handover, which causes the throughput drop and the communication interruption.

Therefore, methods for handling the handover to maintain the throughput and to avoid the communication interruption are highly required.

### SUMMARY

It is an objective of the invention to provide a connection recovery method and an associated communication apparatus, in order to solve the above problem.

An embodiment of the invention provides a communication apparatus comprising a radio transceiver and a modem processor. The radio transceiver is configured to transmit or receive wireless signals in a wireless network. The modem processor is coupled to the radio transceiver and configured to perform operations comprising: connecting to a first network device via a first communication link in a first frequency band; predicting a handover according to at least one of at least one measurement result or location information; connecting to a second network device via a second communication link in a second frequency band, after predicting the handover; performing the handover from the first network device to a third network device, to stop connecting to the first network device and to connect to the third network device via the first communication link in the first frequency band; and stopping connecting to the second network device, after performing the handover.

An embodiment of the invention provides a communication apparatus comprising a radio transceiver and a modem processor. The radio transceiver is configured to transmit or receive wireless signals in a wireless network. The modem processor is coupled to the radio transceiver and configured to perform operations comprising: connecting to a first network device via a first communication link in a first frequency band; predicting a handover according to at least one of at least one measurement result or location information; connecting to a second network device via a second communication link in a second frequency band and not performing a transmission to the first network device, after predicting the handover; performing the handover from the first network to a third network, to stop connecting to the first network device and to connect to the third network device via the first communication link in the first frequency band; and stopping connecting to the second network device, after performing the handover.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows an exemplary block diagram of a communication apparatus according to an embodiment of the invention.

FIG. 2 shows an exemplary block diagram of a modem according to an embodiment of the invention.

FIG. 3 is a flowchart of a process according to an embodiment of the invention.

FIG. 4 is a schematic diagram of a data transmission according to an embodiment of the invention.

FIG. 5 is a schematic diagram of a data transmission according to an embodiment of the invention.

FIG. 6 is a flowchart of a process according to an embodiment of the invention.

FIG. 7 is a schematic diagram of a data transmission according to an embodiment of the invention.

FIG. 8 is a schematic diagram of a scenario in a wireless network according to an embodiment of the invention.

FIG. 9 is a schematic diagram of a scenario in a wireless network according to an embodiment of the invention.

### DETAILED DESCRIPTION

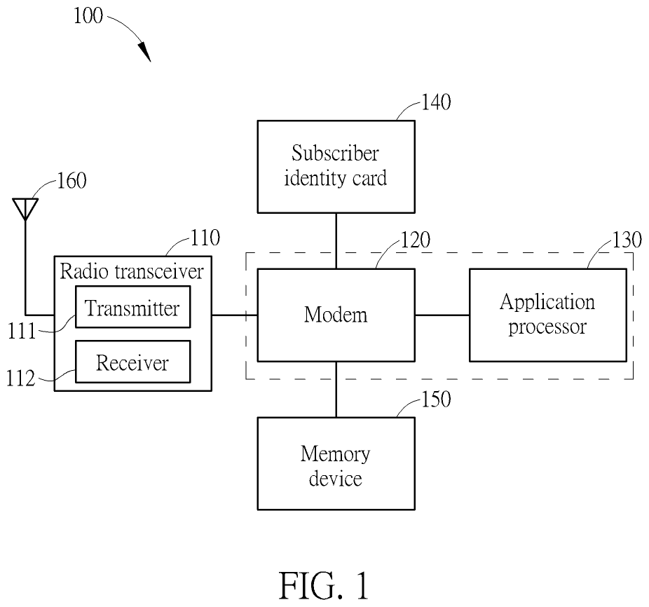

FIG. 1 shows an exemplary block diagram of a communication apparatus 100 according to an embodiment of the invention. The communication apparatus 100 may be a portable electronic device, such as a Mobile Station (MS, which may be interchangeably referred to as User Equipment (UE)). The communication apparatus 100 may comprise at least an antenna module comprising a radio transceiver 110, a modem 120, an application processor 130, a subscriber identity card 140, a memory device 150 and at least one antenna 160. The radio transceiver 110 maybe configured to transmit and/or receive wireless signals to and/or from a network device in a wireless network via the antenna module, so as to communicate with the network device via a communication link established between the communication apparatus 100 and the network device. The radio transceiver 110 may comprise a receiver 112 configured to receive wireless signals from the air interface and a transmitter 111 configured to transmit wireless signals to the air interface, and the radio transceiver 110 may be further configured to perform radio frequency (RF) signal processing. For example, the receiver 112 may convert the received signals into intermediate frequency (IF) or baseband signals to be processed, or the transmitter 111 may receive the IF or baseband signals from the modem 120 and convert the received signals into wireless signals to be transmitted to the network device in the wireless network or in an access network (e.g., acellular network or a wireless local access network). According to an embodiment of the invention, the network device may be a cell, a Node-B (NB), an evolved Node-B (eNB), a g Node-B (gNB), a base station, a Mobility Management Entity (MME), an Access and Mobility Management Function (AMF) device, an Access Point (AP), etc., at the network side and communicating with the communication apparatus 100 by the wireless signals via the communication link.

The transmitter 111 and the receiver 112 of the radio transceiver 110 may comprise a plurality of hardware devices to perform RF conversion and RF signal processing. For example, the transmitter 111 and/or the receiver 112 may comprise a power amplifier for amplifying the RF signals, a filter for filtering unwanted portions of the RF signals and/or a mixer for performing radio frequency conversion. According to an embodiment of the invention, the radio frequency may be, for example, the frequency of any specific frequency band for a LTE system, or the frequency of any specific frequency band for a 5G NR system, the frequency of any specific frequency band for a WiFi system, etc.

The modem 120 may be configured to handle corresponding communications protocol operations and processing the IF or baseband signals received from or to be transmitted to the radio transceiver 110. The application processor 130 is configured to run the operating system of the communication apparatus 100 and run application programs installed in the communication apparatus 100. In the embodiments of the invention, the modem 120 and the application processor 130 may be designed as discrete chips with some buses or hardware interfaces coupled therebetween, or they may be integrated into a combo chip (i.e., a system on chip (SoC)), and the invention should not be limited thereto.

The subscriber identity card 140 may be a subscriber identity module (SIM), universal mobile telecommunications system (UMTS) SIM (USIM), removable user identity module (R-UIM) or code division multiple access (CDMA) SIM (CSIM) card, or the like and may typically contain user account information, an International Mobile Subscriber Identity (IMSI) and a set of SIM application toolkit (SAT) commands and may provide storage space for phone book contacts. The memory device 150 may be coupled to the modem 120 and application processor 130 and may store system data or user data.

It should be noted that, in order to clarify the concept of the invention, FIG. 1 presents a simplified block diagram in which only the elements relevant to the invention are shown. For example, in some embodiments of the invention, the communication apparatus may further comprise some peripheral devices not shown in FIG. 1. In another example, in some embodiments of the invention, the communication apparatus may further comprise a central controller coupled to the modem 120 and the application processor 130. Therefore, the invention should not be limited to what is shown in FIG. 1.

In some embodiments of the invention, the communication apparatus is capable of supporting multiple radio access technologies (RATs) communications via the single-card structure as shown in FIG. 1. It should be noted that, although FIG. 1 shows a single-card application, the invention should not be limited thereto. For example, in some embodiments of the invention, the communication apparatus may comprise multiple subscriber identity cards to support the multi-RATs communications, in either a single-standby or a multiple-standby manner. In the multi-RATs communications applications, the modem, the radio transceiver and/or the antenna module may be shared by the subscriber identity card(s) and may have the capability of handling the operations of different RATs and processing the corresponding RF, IF or baseband signals in compliance with the corresponding communications protocols.

In addition, those who are skilled in this technology can still make various alterations and modifications based on the descriptions given above to derive the communication apparatuses comprising multiple radio transceivers and/or multiple antenna modules for supporting multi-RAT wireless communications without departing from the scope and spirit of this invention. Therefore, in some embodiments of the invention, the communication apparatus may be designed to support a multi-card application, in either a single-standby or a multiple-standby manner, by making some alterations and modifications.

It should be further noted that the subscriber identity card 140 may be dedicated hardware cards as described above, or in some embodiments of the invention, there may be virtual cards, such as individual identifiers, numbers, addresses, or the like which are burned in the internal memory device of the corresponding modem and are capable of identifying the communication apparatus. Therefore, the invention should not be limited to what is shown in the figures.

It should be further noted that in some embodiments of the invention, the communication apparatus may further support multiple IMSIs.

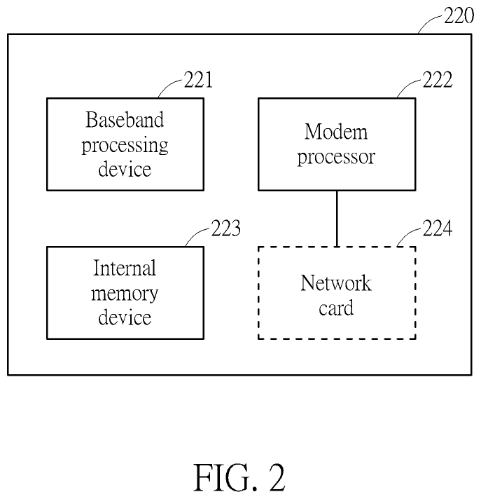

FIG. 2 shows an exemplary block diagram of a modem 220 according to an embodiment of the invention. The modem 220 may be the modem 120 shown in FIG. 1 and may comprise at least a baseband processing device 221, a processor 222 (to discriminate from the “application processor” shown in FIG. 1, hereinafter named the “modem processor”), an internal memory device 223 and a network card 224. The baseband processing device 221 may receive the IF or baseband signals from the radio transceiver 110 and perform IF or baseband signal processing. For example, the baseband processing device 221 may convert the IF or baseband signals into a plurality of digital signals, and process the digital signals, and vice versa. The baseband processing device 221 may comprise a plurality of hardware devices to perform signal processing, such as an analog-to-digital converter for ADC conversion, a digital-to-analog converter for DAC conversion, an amplifier for gain adjustment, a modulator for signal modulation, a demodulator for signal demodulation, an encoder for signal encoding, a decoder for signal decoding, and so on.

According to an embodiment of the invention, the baseband processing device 221 may be designed to have the capability of handling the baseband signal processing operations for different RATs and processing the corresponding IF or baseband signals in compliance with the corresponding communications protocols, so as to support the multi-RAT wireless communications. According to another embodiment of the invention, the baseband processing device 221 may comprise a plurality of sub-units, each being designed to have the capability of handling the baseband signal processing operations of one or more specific RATs and processing the corresponding IF or baseband signals in compliance with the corresponding communications protocols, so as to support the multi-RAT wireless communications. Therefore, the invention should not be limited to any specific way of implementation.

The modem processor 222 may control the operations of the modem 220. According to an embodiment of the invention, the modem processor 222 maybe arranged to execute the program codes of the corresponding software module of the modem 220. The modem processor 222 may maintain and execute the individual tasks, threads, and/or protocol stacks for different software modules. In an embodiment, a protocol stack may be implemented so as to respectively handle the radio activities of one RAT. However, it is also possible to implement more than one protocol stack to handle the radio activities of one RAT at the same time, or implement only one protocol stack to handle the radio activities of more than one RAT at the same time, and the invention should not be limited thereto.

The modem processor 222 may also read data from the subscriber identity card coupled to the modem, such as the subscriber identity card 140, and write data to the subscriber identity card. The internal memory device 223 may store system data and user data for the modem 220. The modem processor 222 may also access the internal memory device 223.

The network card 224 provides Internet access services for the communication apparatus. It should be noted that, although the network card 224 shown in FIG. 2 is configured inside of the modem, the invention should not be limited thereto. In some embodiments of the invention, the communication apparatus may also comprise a network card configured outside of the modem, or the communication apparatus may also be coupled to an external network card for providing Internet access services. In some embodiments of the invention, the network card 224 may be a virtual network card, instead of a tangible card, that is created by the operating system of the communication apparatus 100. Therefore, the invention should not be limited to any specific implementation method.

It should be noted that, in order to clarify the concept of the invention, FIG. 2 presents simplified block diagrams in which only the elements relevant to the invention are shown. Therefore, the invention should not be limited to what is shown in FIG. 2.

It should be further noted that in some embodiments of the invention, the modem may also comprise more than one processor and/or more than one baseband processing device. For example, the modem may comprise multiple processors and/or multiple baseband processing devices for supporting multi-RAT operations. Therefore, the invention should not be limited to what is shown in FIG. 2.

It should be further noted that in some embodiments of the invention, the baseband processing device 221 and the modem processor 222 may be integrated into one processing unit, and the modem may comprise one or multiple such processing units, for supporting multi-RAT operations. Therefore, the invention should not be limited to what is shown in FIG. 2.

According to an embodiment of the invention, the modem processor 222 and the application processor 130 may comprise a plurality of logics, each, designed for handling one or more functionalities. The logics maybe configured to execute the program codes of one or more software and/or firmware modules, thereby performing the corresponding operations. When performing the corresponding operations by executing the corresponding programs, the logics may be regarded as dedicated hardware devices or circuits, such as dedicated processor sub-units. Generally, the modem processor 222 may be configured to perform operations of relative lower protocol layers while the application processor 130 may be configured to perform operations of relative higher protocol layers. Therefore, in some embodiments of the invention, the application processor 130 may be regarded as the upper layer entity or upper layer processing circuit with respect to the modem processor 222 and the modem processor 222 maybe regarded as the lower layer entity or lower layer processing circuit with respect to the application processor 130.

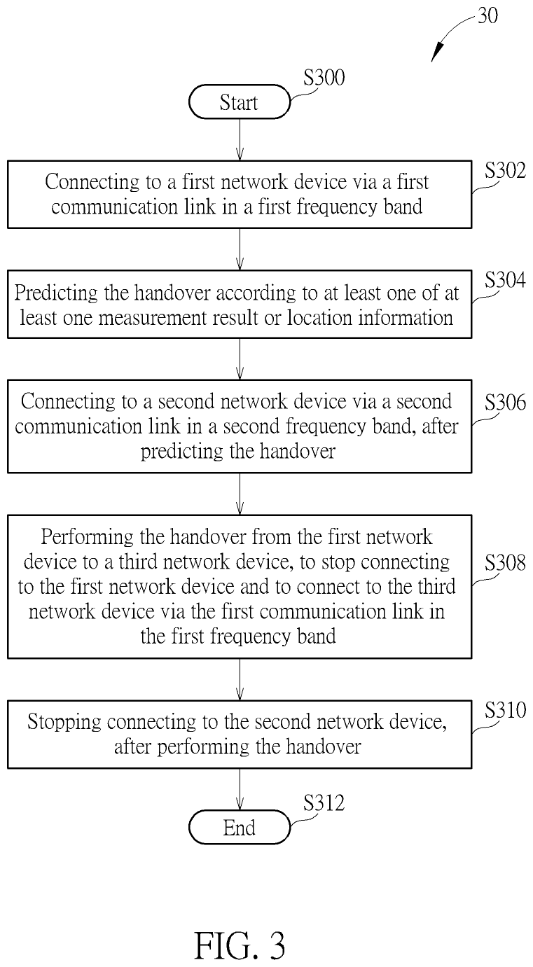

FIG. 3 is a flowchart of a process 30 utilized in a communication apparatus to handle a handover in a wireless network. The process 30 comprises the following steps:

Step S300:Start.

Step S302:Connecting to a first network device via a first communication link in a first frequency band.

Step S304:Predicting the handover according to at least one of at least one measurement result or location information.

Step S306:Connecting to a second network device via a second communication link in a second frequency band, after predicting the handover.

Step S308:Performing the handover from the first network device to a third network device, to stop connecting to the first network device and to connect to the third network device via the first communication link in the first frequency band.

Step S310:Stopping connecting to the second network device, after performing the handover.

Step S312:End.

Realization of the process 30 is not limited to the above description. The following embodiments of the invention may be applied to realize the process 30.

In an embodiment of the invention, first data transmitted via the first communication link is the same as second data transmitted via the second communication link. In an embodiment of the invention, first data transmitted via the first communication link is different from second data transmitted via the second communication link.

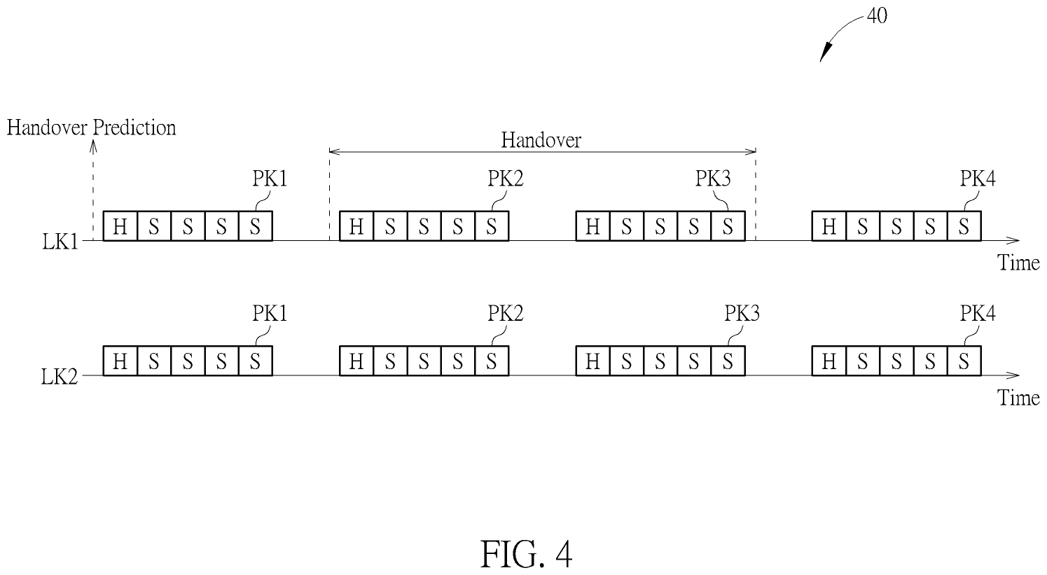

FIG. 4 is a schematic diagram of a data transmission 40 according to an embodiment of the invention. The communication apparatus in the process 30 transmits first data via a communication link LK1 and second data via a communication link LK2 at the same time. The first data and the second data comprise packets PK1, PK2, PK3 and PK4. Each packet comprises a header H and a plurality of symbols S (e.g., 4 symbols). In detail, the communication apparatus transmits the packet PK1 to the first network device in the process 30 via the communication link LK1 before performing a handover, and transmits the packet PK4 to the third network device in the process 30 via the communication link LK1 after performing the handover. The communication apparatus fails to transmit the packets PK2 and PK3 via the communication link LK1 during performing the handover, which causes a throughput drop and a communication interruption. The communication apparatus transmits the packets PK1, PK2, PK3 and PK4 to the second network device in the process 30 via the communication link LK2, after predicting the handover on the communication link LK1. Therefore, the packets PK2 and PK3 are transmitted successfully by the communication apparatus, and the throughput drop and the communication interruption are avoided.

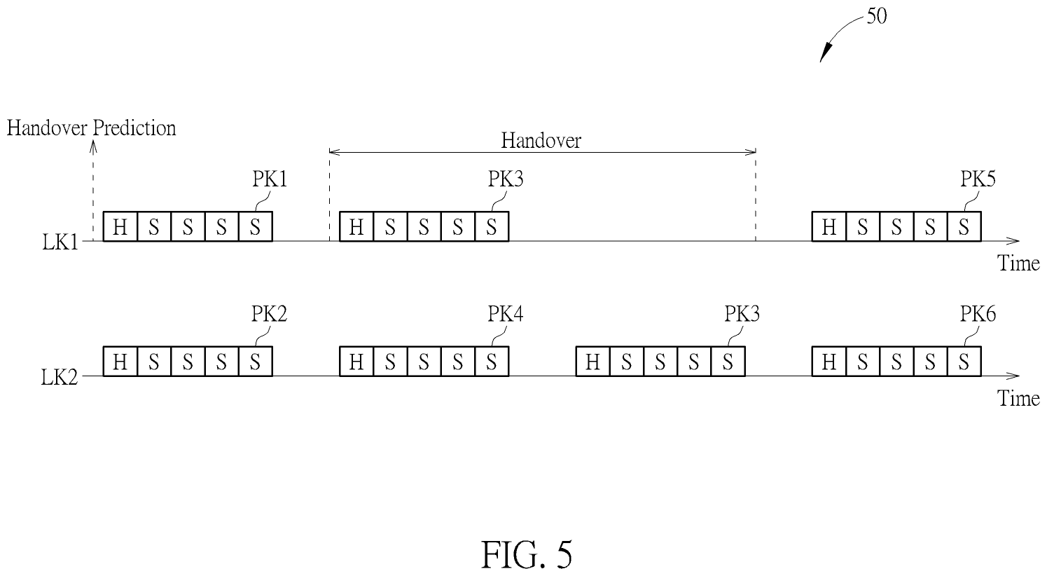

FIG. 5 is a schematic diagram of a data transmission 50 according to an embodiment of the invention. The communication apparatus in the process 30 transmits first data via a communication link LK1 and second data via a communication link LK2. The first data comprises packets PK1, PK3 and PK5. The second data comprises packets PK2, PK3, PK4 and PK6. Each packet comprises a header H and a plurality of symbols S (e.g., 4 symbols). In detail, the communication apparatus transmits the packet PK1 to the first network device in the process 30 via the communication link LK1 before performing a handover, and transmits the packet PK5 to the third network device in the process 30 via the communication link LK1 after performing the handover. The communication apparatus fails to transmit the packet PK3 via the communication link LK1 during performing the handover, which causes a throughput drop and a communication interruption. The communication apparatus transmits the packets PK2 and PK4 to the second network device in the process 30 via the communication link LK2, after predicting the handover on the communication link LK1. Then, the communication apparatus finds that the packet PK3 fails to be transmitted via the communication link LK1, retransmits the packet PK3 to the second network device via the communication link LK2, and transmits the packet PK6 via the communication link LK2. That is, the communication apparatus transmits the packets PK2, PK3, PK4 and PK6 (e.g., out of order) to the second network device via the communication link LK2, after predicting the handover. Therefore, the packet PK3 is transmitted successfully by the communication apparatus, and the throughput drop and the communication interruption are avoided. In addition, the data aggregation transmission 50 provides a better data rate than the data duplication transmission 40 shown in FIG. 4.

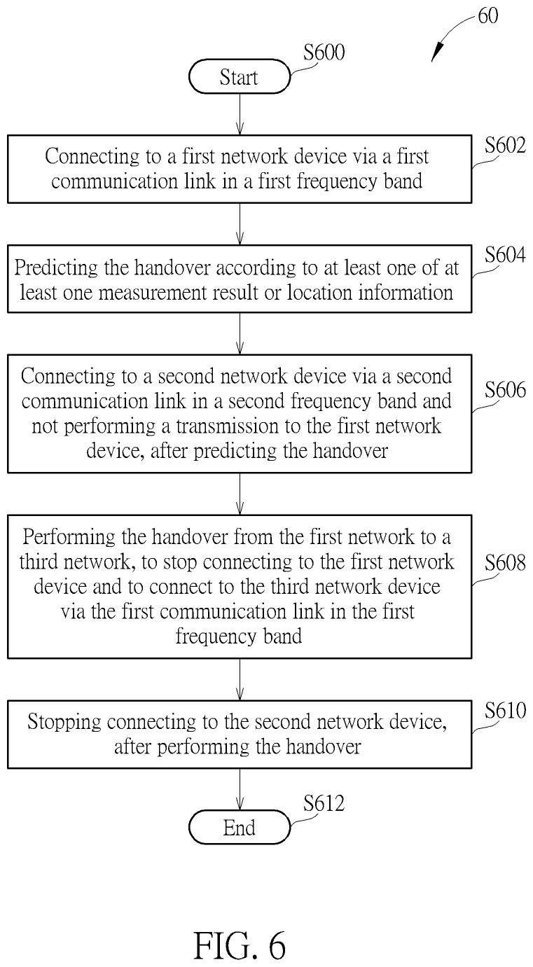

FIG. 6 is a flowchart of a process 60 utilized in a communication apparatus to handle a handover in a wireless network. The process 60 comprises the following steps:

Step S600:Start.

Step S602:Connecting to a first network device via a first communication link in a first frequency band.

Step S604:Predicting the handover according to at least one of at least one measurement result or location information.

Step S606:Connecting to a second network device via a second communication link in a second frequency band and not performing a transmission to the first network device, after predicting the handover.

Step S608:Performing the handover from the first network to a third network, to stop connecting to the first network device and to connect to the third network device via the first communication link in the first frequency band.

Step S610:Stopping connecting to the second network device, after performing the handover.

Step S612:End.

Realization of the process 60 is not limited to the above description. The following embodiment of the invention may be applied to realize the process 60.

In an embodiment of the invention, first data transmitted via the first communication link is different from second data transmitted via the second communication link.

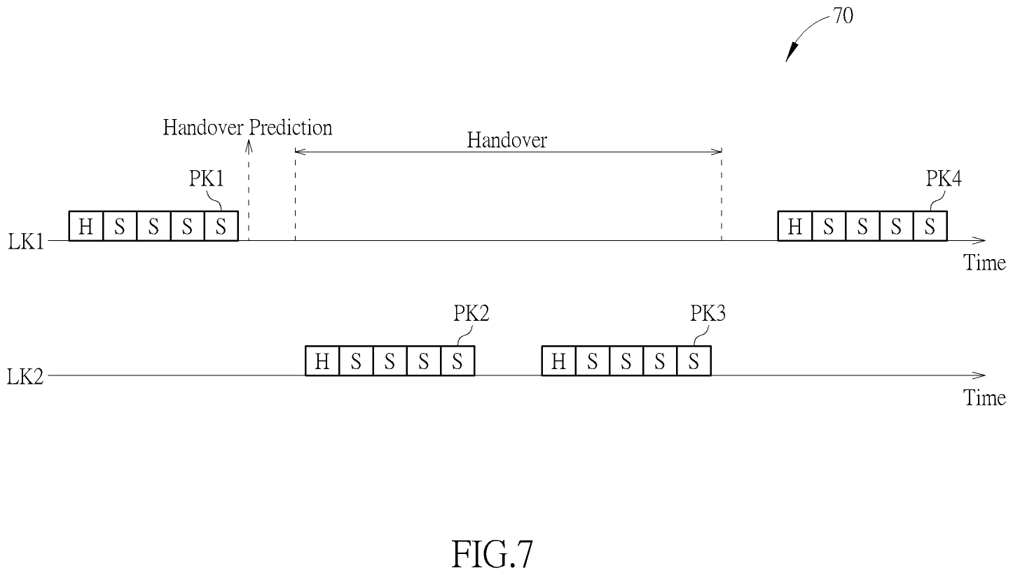

FIG. 7 is a schematic diagram of a data transmission 70 according to an embodiment of the invention. The communication apparatus in the process 60 transmits first data via a communication link LK1 and second data via a communication link LK2. The first data comprises packets PK1 and PK4. The second data comprises packets PK2 and PK3. Each packet comprises a header H and a plurality of symbols S (e.g., 4 symbols). In detail, the communication apparatus transmits the packet PK1 to the first network device in the process 60 via the communication link LK1. Then, the communication apparatus transmits the packets PK2 and PK3 to the second network device in the process 60 via the communication link LK2, after predicting a handover via the communication link LK1. The communication apparatus transmits the packet PK4 to the third network device in the process 60 via the communication link LK1, after performing the handover. That is, the communication apparatus does not perform a transmission via the communication link LK1 during performing the handover. The communication apparatus switches the communication link to transmit the packets, and the packets are transmitted successfully.

The following embodiments of the invention may be applied to realize the processes 30 and 60.

In an embodiment of the invention, a first SIM in the communication apparatus for connecting to the first network device and the third network device is different from a second SIM in the communication apparatus for connecting to the second network device. In the case of the embodiment applied to the process 30, the communication apparatus transmits the first data via the first SIM and the second data via the second SIM (e.g., at the same time), after predicting the handover. In the case of the embodiment applied to the process 60, the communication apparatus switches from the first SIM to the second SIM after predicting the handover, and switches from the second SIM to the first SIM after performing the handover. In an embodiment of the invention, a first mobile network operation (MNO) of the first SIM is different from a second MNO of the second SIM. In an embodiment of the invention, the first MNO of the first SIM is the same as the second MNO of the second SIM.

In an embodiment of the invention, the communication apparatus predicts the handover according to at least one behavior of the communication apparatus related to the second SIM. In an embodiment of the invention, the at least one behavior of the communication apparatus related to the second SIM comprises a reception (e.g., a discontinuous reception (DRX), a paging reception, a system information block (SIB) reception) performed via the second SIM, a cell reselection performed via the second SIM and/or data transmissions/receptions (e.g., a tracking area update (TAU) procedure and/or a mobility registration update (MRU) procedure) performed via the second SIM. In an embodiment of the invention, the communication apparatus predicts the handover according to a measurement gap of a measurement (e.g., performed via the first SIM). That is, the handover is predicted by the communication apparatus according to a communication interruption event.

In an embodiment of the invention, the communication apparatus predicts the handover according to a measurement event. For example, the communication apparatus knows that the handover from the first network device to the third network device will occur, when a measurement event A3 (e.g., a cell of the third network device has a better performance than a cell of the first network device) is reported. That is, the handover is predicted by the communication apparatus according to a history/statistics of handover events.

In an embodiment of the invention, the at least one measurement result comprises at least one of a measurement result of a radio quality, at least one first measurement result of the first network device, at least one second measurement result of the second network device or at least one third measurement result of the third network device. In an embodiment of the invention, the at least one first measurement result comprises at least one measurement result of signal power of the first network device. In an embodiment of the invention, the at least one second measurement result comprises a measurement result of intra/inter-frequency neighbor network devices (e.g., measured via the second SIM) and/or a measurement result of inter-RAT neighbor network devices (e.g., measured via the second SIM). In an embodiment of the invention, the at least one third measurement result comprises a measurement result of inter-frequency neighbor network devices (e.g., measured via the first SIM) and/or a measurement result of inter-RAT neighbor network devices (e.g., measured via the first SIM).

In an embodiment of the invention, the communication apparatus obtains the location information related to at least one of the communication apparatus, the first network device, the second network device or the third network device according to at least one of a sensor of the communication apparatus or a database of a network device map. That is, the handover is predicted by the communication apparatus according to location(s) of the communication apparatus, the first network device, the second network device and/or the third network device.

In an embodiment of the invention, the communication apparatus predicts the handover according to a first thread of the communication apparatus. A second thread of other communication apparatus records signal strength information of signals received from network devices (e.g., the first network device and the third network device in the processes 30 and 60), and transmits the signal strength information to nearby threads. The nearby threads are located at edges of coverage areas of the network devices, and store the signal strength information. The nearby threads transmit the signal strength information to the first thread of the communication apparatus, when the communication apparatus is in the coverage areas of the network devices. That is, the handover is predicted by the communication apparatus according to the signal strength information received by the first thread of the communication apparatus. In an embodiment of the invention, the network devices may be APs or AP routers.

In an embodiment of the invention, the first network device is a NB or an AP. In an embodiment of the invention, the second network device is a NB or an AP. In an embodiment of the invention, the third network device is a NB, an AP or a null network device. In an embodiment of the invention, a coverage area of the null network device is an area without any signal (e.g., WiFi signal). In an embodiment of the invention, the wireless network comprises a cellular network and/or a wireless local area network (WLAN) (e.g., WiFi).

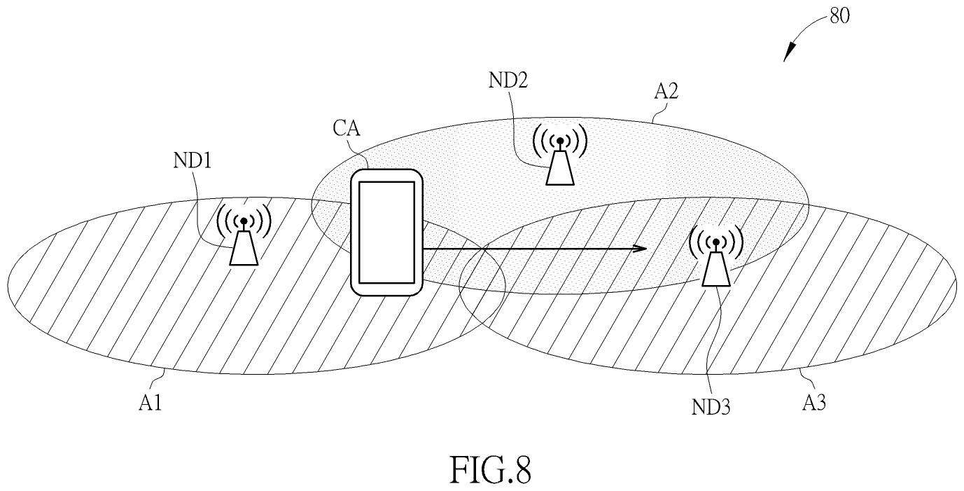

FIG. 8 is a schematic diagram of a scenario 80 in a wireless network according to an embodiment of the invention. In the scenario 80, a communication apparatus CA, network devices NDl, ND2 and ND3 are in the wireless network. The network devices NDl and ND3 are NBs or APs. The network device ND2 is a NB or an AP. Areas A1, A2 and A3 are coverage areas of the network devices ND1, ND2 and ND3, respectively. A direction of an arrow shown in FIG. 8 is a moving direction of the communication apparatus CA. The communication apparatus CA connects to the network device ND1 (e.g., Step S302 in the process 30 or Step S602 in the process 60). Then, the communication apparatus CA detects a signal power reduction (or a signal quality reduction) of the network device ND1, when moving from the network device ND1 to the network device ND3 according to the direction of the arrow. The communication apparatus CA predicts a handover (or a roaming) from the network device NDl to the network device ND3 (e.g., Step S304 in the process 30 or Step S604 in the process 60). The handover causes a throughput drop and a communication interruption of the communication apparatus CA. Then, the communication apparatus CA performs Steps S306, 5308 and 5310 in the process 30, or performs Steps S606, 5608 and 5610 in the process 60, to avoid the throughput drop and the communication interruption. The handover prediction can be referred to the above embodiments of the invention, and is not narrated herein.

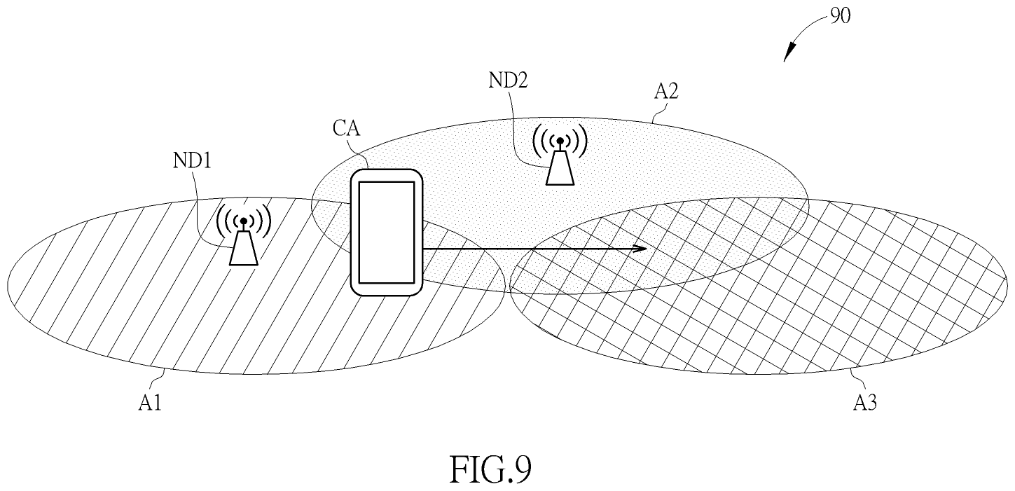

FIG. 9 is a schematic diagram of a scenario 90 in a wireless network according to an embodiment of the invention. In the scenario 90, a communication apparatus CA and network devices NDl and ND2 are in the wireless network. The network device NDl is an AP. The network device ND2 is a NB. Areas A1 and A2 are coverage areas of the network devices ND1 and ND2, respectively. There is no WiFi signal in an area A3 (e.g., a coverage area of a null network device). A direction of an arrow shown in FIG. 9 is a moving direction of the communication apparatus CA. The communication apparatus CA connects to the network device ND1 via a first communication link. The communication apparatus CA detects a signal power reduction (or a signal quality reduction) of the network device ND1, when moving from the network device ND1 to the area A3 (e.g., moving to the null network device) according to the direction of the arrow. The communication apparatus CA suffers a throughput drop and a communication interruption from the signal quality reduction. Then, the communication apparatus CA connects to the network device ND2 via a second communication link, to avoid the throughput drop and the communication interruption.

To sum up, the present invention provides a communication apparatus and a method for handling a handover in a wireless network. The communication apparatus predicts the handover from the first network device to the third network device via the first communication link, and connects to the second network device via the second communication link. Therefore, the problem of handling the handover to maintain the throughput and to avoid the communication interruption can be solved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communication apparatus, comprising:
a radio transceiver, transmitting or receiving wireless signals in a wireless network; and
a modem processor, coupled to the radio transceiver and configured to perform operations comprising:
connecting to a first network device via a first communication link in a first frequency band;
predicting a handover according to at least one of at least one measurement result or location information;
connecting to a second network device via a second communication link in a second frequency band, after predicting the handover;
performing the handover from the first network device to a third network device, to stop connecting to the first network device and to connect to the third network device via the first communication link in the first frequency band; and
stopping connecting to the second network device, after performing the handover.

2. The communication apparatus of claim 1, wherein first data transmitted via the first communication link is the same as second data transmitted via the second communication link.

3. The communication apparatus of claim 1, wherein first data transmitted via the first communication link is different from second data transmitted via the second communication link.

4. The communication apparatus of claim 1, wherein a first subscriber identity module (SIM) in the communication apparatus for connecting to the first network device and the third network device is different from a second SIM in the communication apparatus for connecting to the second network device.

5. The communication apparatus of claim 4, wherein the communication apparatus predicts the handover according to at least one behavior of the communication apparatus related to the second SIM.

6. The communication apparatus of claim 1, wherein the communication apparatus predicts the handover according to a measurement event.

7. The communication apparatus of claim 1, wherein the at least one measurement result comprises at least one of a measurement result of a radio quality, at least one first measurement result of the first network device, at least one second measurement result of the second network device or at least one third measurement result of the third network device.

8. The communication apparatus of claim 1, wherein the communication apparatus obtains the location information related to at least one of the communication apparatus, the first network device, the second network device or the third network device according to at least one of a sensor of the communication apparatus or a database of a network device map.

9. The communication apparatus of claim 1, wherein the communication apparatus predicts the handover according to a thread of the communication apparatus.

10. The communication apparatus of claim 1, wherein the first network device is a Node-B (NB) or an Access Point (AP), and the second network device is a NB or an AP.

11. The communication apparatus of claim 1, wherein the third network device is a NB, an AP or a null network device.

12. A communication apparatus, comprising:
a radio transceiver, transmitting or receiving wireless signals in a wireless network; and
a modem processor, coupled to the radio transceiver and configured to perform operations comprising:
connecting to a first network device via a first communication link in a first frequency band;
predicting a handover according to at least one of at least one measurement result or location information;
connecting to a second network device via a second communication link in a second frequency band and not performing a transmission to the first network device, after predicting the handover;
performing the handover from the first network to a third network, to stop connecting to the first network device and to connect to the third network device via the first communication link in the first frequency band; and
stopping connecting to the second network device, after performing the handover.

13. The communication apparatus of claim 12, wherein a first subscriber identity module (SIM) in the communication apparatus for connecting to the first network device and the third network device is different from a second SIM in the communication apparatus for connecting to the second network device.

14. The communication apparatus of claim 13, wherein the communication apparatus predicts the handover according to at least one behavior of the communication apparatus related to the second SIM.

15. The communication apparatus of claim 12, wherein the communication apparatus predicts the handover according to a measurement event.

16. The communication apparatus of claim 12, wherein the at least one measurement result comprises at least one of a measurement result of a radio quality, at least one first measurement result of the first network device, at least one second measurement result of the second network device or at least one third measurement result of the third network device.

17. The communication apparatus of claim 12, wherein the communication apparatus obtains the location information related to at least one of the communication apparatus, the first network device, the second network device or the third network device according to at least one of a sensor of the communication apparatus or a database of a network device map.

18. The communication apparatus of claim 12, wherein the communication apparatus predicts the handover according to a thread of the communication apparatus.

19. The communication apparatus of claim 12, wherein the first network device is a Node-B (NB) or an Access Point (AP), and the second network device is a NB or an AP.

20. The communication apparatus of claim 12, wherein the third network device is a NB, an AP or a null network device.
